(19) United States
(12) Patent Application Publication
(10) Pub. No.: US 2026/0197046 A1
(43) Pub. Date: Jul. 9, 2026

(54) METHODS FOR ENABLING MULTI-LINK MILLIMETER WAVE BEAM TRAINING

(71) Applicant: INTERDIGITAL PATENT HOLDINGS, INC., Wilmington, DE (US)

(72) Inventors: Mahmoud SAAD, Montreal (CA); Hanqing Lou, Syosset, NY (US); Zinan Lin, Basking Ridge, NJ (US); Xiaofei Wang, North Caldwell, NJ (US); Rui Yang, Melville, NY (US)

(73) Assignee: INTERDIGITAL PATENT HOLDINGS, INC., Wilmington, DE (US)

(21) Appl. No.: 19/131,657

(22) PCT Filed: Nov. 17, 2023
(86) PCT No.: PCT/US2023/080270

§ 371 Date: May 21, 2025

Related U.S. Application Data
(60) Provisional application No. 63/427,006, filed on Nov. 21, 2022.

(51) Int. Cl. H04B 7/06; H04B 17/309; H04L 1/00; H04W 74/0816

(52) U.S. Cl. CPC H04B 7/0617; H04B 17/346; H04L 1/0068; H04W 74/0816

(57) ABSTRACT

Methods for enabling multi-link millimeter wave (mmW) beam training are provided herein. A method performed by a station (STA), may include: receiving, on a sub-7 GHz link of the STA, a null data packet (NDP) announcement (NDPA) frame, wherein the NDPA includes information to initiate a millimeter wave (mmW) beam training process; determining that at least one STA Info field included in the NDPA frame includes an association ID (AID) subfield that matches an AID associated with the STA; receiving, based on information included in the STA Info field, one or more NDP physical layer protocol data units (PPDUs) on a mmW link; and transmitting, on the sub-7 GHz link, a beam training feedback report based on the one or more NDP PPDUs received on the mmW link.

### CROSS-REFERENCE TO RELATED APPLICATIONS

This application claims the benefit of U.S. Provisional Application No. 63/427,006, filed Nov. 21, 2022, the contents of which are incorporated herein by reference.

### BACKGROUND

A wireless local-area network (WLAN) in Infrastructure Basic Service Set (BSS) mode has an access point (AP) for the BSS and one or more stations (STAs) associated with the AP. The AP may have access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, may sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A160 MHz channel may be formed either by combining 8 contiguous 20 MHz channels, or by combining two non-contiguous 80 MHz channels, which may also be referred to as an 80+80 configuration. For the 80+80 configuration, the data, after channel encoding, is passed through a segment parser that divides it into two streams. The Inverse Discrete Fourier Transformation (IDFT) operation and time domain processing are done on each stream separately. The streams are then mapped on to the two channels, and the data is transmitted. At the receiver, this mechanism is reversed, and the combined data is sent to the MAC.

To improve spectral efficiency 802.11ac has introduced the concept for downlink Multi-User MIMO (MU-MIMO) transmission to multiple STA's in the same symbol's time frame, e.g., during a downlink OFDM symbol. The potential for the use of downlink MU-MIMO is also currently considered for 802.11ah. It is 8207152.1 important to note that since downlink MU-MIMO, as it is used in 802.11ac, uses the same symbol timing to multiple STA's interference of the waveform transmissions to multiple STA's is not an issue. However, all STA's involved in MU-MIMO transmission with the AP must use the same channel or band, this limits the operating bandwidth to the smallest channel bandwidth that is supported by the STA's which are included in the MU-MIMO transmission with the AP.

### SUMMARY

Methods for enabling multi-link millimeter wave (mmW) beam training are provided herein. A method performed by a station (STA), may include: receiving, on a sub-7 GHz link of the STA, a null data packet (NDP) announcement (NDPA) frame, wherein the NDPA includes information to initiate a millimeter wave (mmW) beam training process; determining that at least one STA Info field included in the NDPA frame includes an association ID (AID) subfield that matches an AID associated with the STA; receiving, based on information included in the STA Info field, one or more NDP physical layer protocol data units (PPDUs) on a mmW link; and transmitting, on the sub-7 GHz link, a beam training feedback report based on the one or more NDP PPDUs received on the mmW link.

The NDPA may include a Common Info field. The Common Info field may include at least one of a Ver subfield, Dialog Token Number subfield, Size of STA Info subfield, BW subfield, Channel Puncturing Info subfield, Nt subfield, Nr subfield, Number of Tx Sectors subfield, Number of Rx Sectors subfield, Number of NDPs subfield, Number of LTFs in each NDP subfield, or NDP Tx Power subfield.

The STA Info field may include at least one of a AID11 subfield, Preferred Tx Sector ID subfield, Preferred Rx Sector ID subfield, BW subfield, mmW Link ID subfield, SNR-report Required subfield, or Blockage SNR Threshold subfield.

The one or more NDP PPDUs may include at least one of a mmW U-SIG field or mmW-SIG field. The mmW U-SIG field may include at least one of a PHY Version subfield, Bandwidth subfield, mmW Band subfield, Direction subfield, BSS color subfield, TXOP subfield, PPDU Type subfield, Channel Puncturing Info subfield, mmW-SIG MCS subfield, or Number of mmW-SIG Symbols subfield. The mmW-SIG field may include at least one of a Number of Sectors subfield, NDP ID subfield, Sector ID subfield, Antenna ID subfield, LTF Size subfield, or Number of LTFs subfield.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment

FIG. 2 is a diagram illustrating an exemplary null data packet (NDP) announcement (NDPA) frame format;

FIG. 3 is a diagram illustrating an exemplary sounding dialog token field format in the NDPA frame;

FIG. 4 is a diagram illustrating an exemplary STA Info field format in an extremely high throughput (EHT) NDPA frame;

FIG. 5 is a diagram illustrating an exemplary NDPA frame format for an ultra-high reliability (UHR) and mmW support;

FIG. 6 is diagram illustrating a first exemplary Common Info field format in the UHR mmW NDPA frame;

FIG. 7 is diagram illustrating an exemplary STA info field format in UHR mmW NDPA frame;

FIG. 8 is a diagram illustrating a first exemplary mmW beam training NDP frame format;

FIG. 9 is a diagram illustrating a second exemplary mmW beam training NDP frame format;

FIG. 10 is a diagram illustrating an exemplary frame exchange sequence of an beam training procedure;

FIG. 11 is a flowchart illustrating an exemplary beam training procedure;

FIG. 12 is diagram illustrating a first exemplary common info field format in the UHR mmW NDPA frame;

FIG. 13 is a diagram illustrating an exemplary frame exchange sequence of a timeslot based beam training procedure;

FIG. 14 is a flowchart illustrating an exemplary timeslot based beam training procedure;

FIG. 15 is a diagram illustrating an exemplary beam recovery element format;

FIG. 16 is a diagram illustrating an exemplary beam recovery control field in the beam recovery element;

FIG. 17 is a diagram illustrating an exemplary Common Info field for a dynamic configuration of a beam recovery procedure; and

FIG. 18 is a flowchart illustrating an exemplary beam failure detection procedure; and

FIG. 19 is a flowchart illustrating an exemplary beam training procedure.

### DETAILED DESCRIPTION

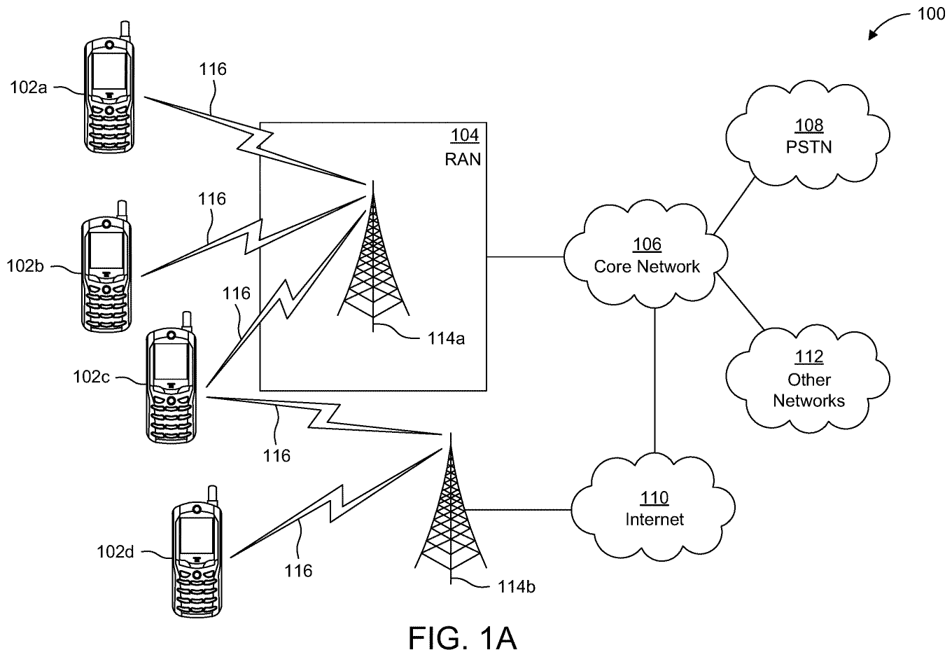

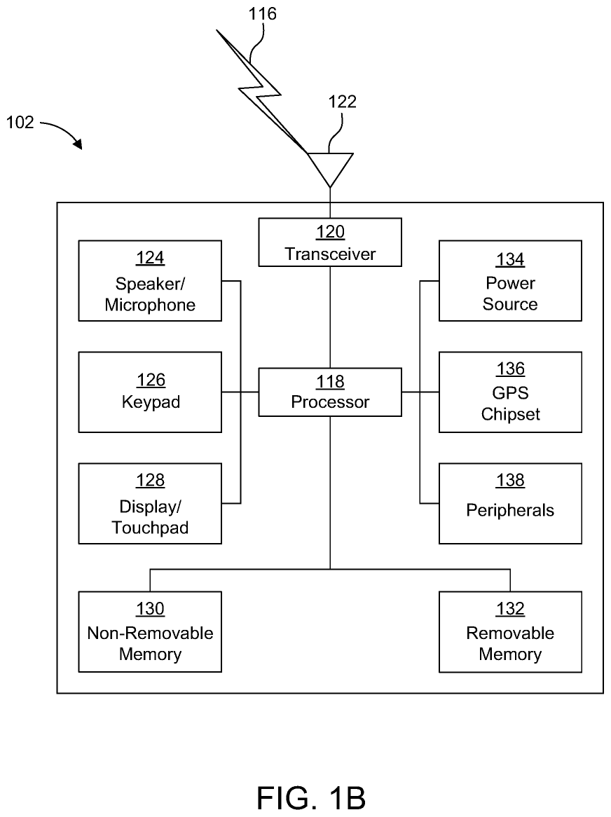

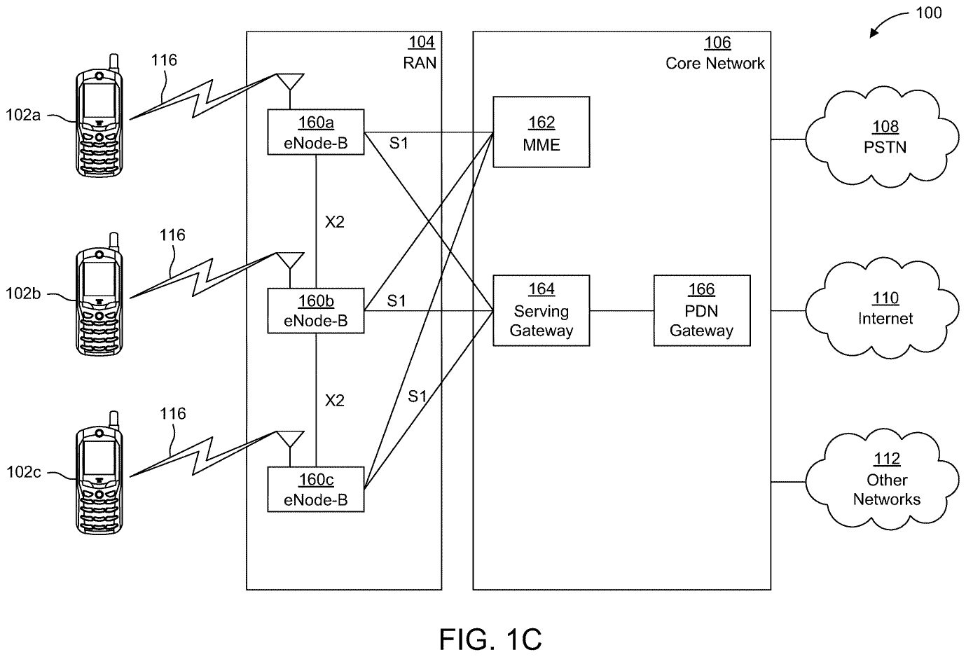

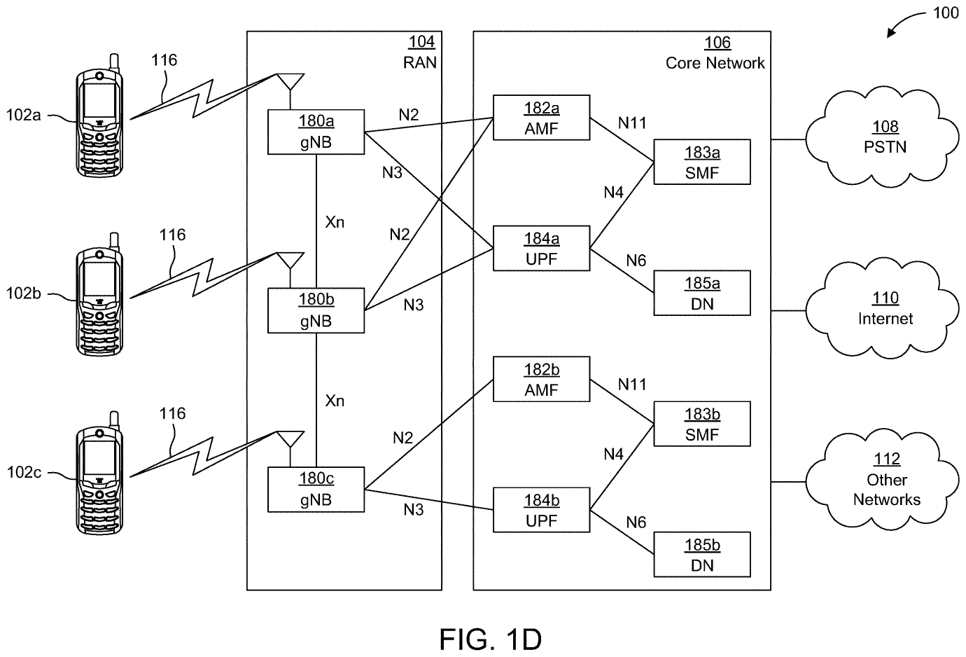

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The IEEE 802.11 UHR Study Group was formed to create a project authorization request (PAR) to create an 802.11 Task Group to standardize improved reliability of WLAN connectivity, reduce latencies, increase manageability, and increase throughput consumption. Millimeter wave (mmW or mmWave) operation is considered as a potential feature to achieve these goals, especially considering the development of multi-link operation (MLO) in 802.11be.

Millimeter wave operation may be the most relevant feature that matches the UHR objectives. All devices operating in mmW band/link may be MLO-capable and may have at least one active sub-7 GHz link. The discovery and association procedure may be done in a lower band/link. Scheduling and broadcast are from a lower band/link. Beamforming (BF) training with sector sweep (SS) is done in mmW band/link, but BF training sequence may be triggered or scheduled from a lower band and feedback can be provided in a lower band.

MLO enables a non-AP multi-link device (MLD) to discover, authenticate, associate, and set up multiple links with an AP MLD. An AP (referred to as reporting AP) affiliated with an AP MLD may advertise operating capabilities and operating parameters of another AP (refer as reported AP) affiliated with the same AP MLD by including Multi-Link Element. Each link enables channel access and frame exchanges between the non-AP MLD and the AP MLD based on the supported capabilities exchanged during association.

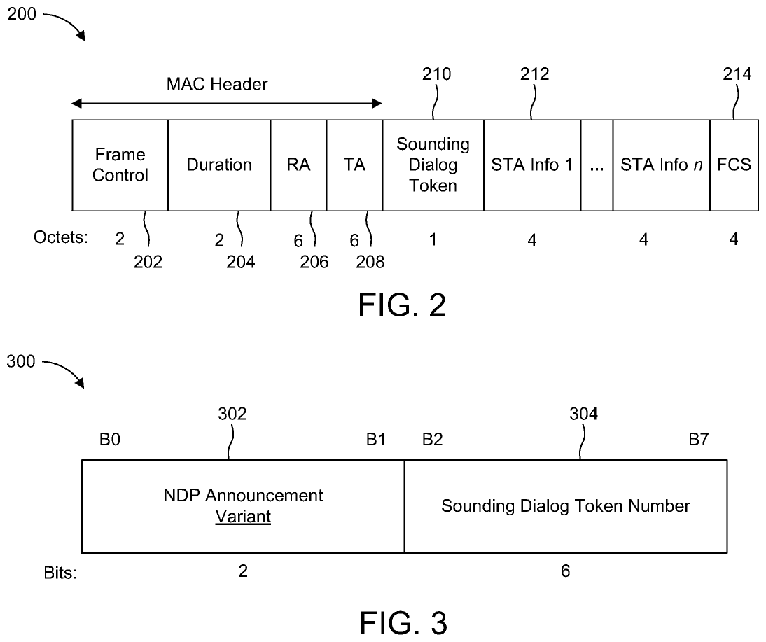

FIG. 2 is an exemplary null data packet (NDP) Announcement (NDPA) frame format 200. The NDPA frame may include a Frame Control field 202, Duration Field 204, RA field 206, TA field 208, Sounding Dialog Token field 210, one or more STA Info fields 212, and FCS field 214.

FIG. 3 is an exemplary Sounding Dialog Token field format 300 in the NDPA frame. The Sounding Dialog Token field may include a NDPA Variant field 302 and Sounding Dialog Token Number field 304. As listed in Table 1 below, in 802.11, there may be four variants of NDPA according to the definition of the Sounding Dialog Token field.

TABLE 1
Definition of Sounding Dialog Token

| NDPA Variant | |
|---|---|
| Subfield | NDPA Frame Variant |
| 0 | VHT NDPA frame |
| 1 | Ranging NDPA frame |
| 2 | HE NDPA frame |
| 3 | EHT NDPA frame |

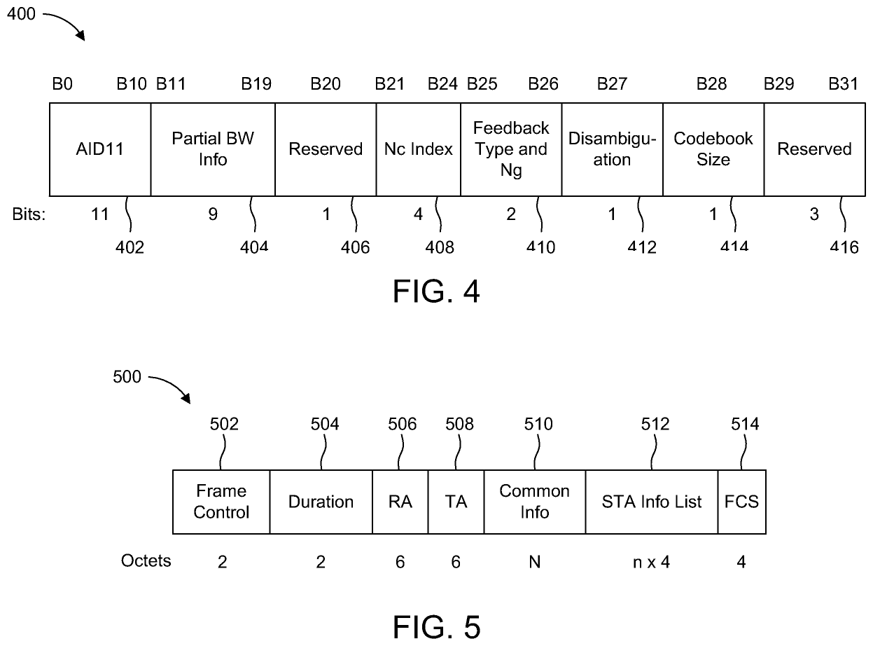

FIG. 4 is an exemplary STA Info field format 400 in an EHT NDPA frame. The STA Info field may include a AID11 field 402, Partial BW Info field 404, Reserved field 406, Nc Index field 408, Feedback Type and Ng field 410, Disambiguation field 412, Codebook Size field 414, and reserved field 416.

One potential problem with mmW signals is that they may be susceptible to changes in the propagation environment and have an inherent limitation due to high propagation loss. Beamforming is an essential requirement for successful operation in mmW. Analog beamforming may be better for mmW operation to reduce the complexity. Locking on the best beam for transmission and reception may require frequent beam training. Under Multi Link Operation (MLO) framework, it may be more efficient to use links in the Sub-7 GHz bands to exchange the control frames (such as NDPA frame and Trigger frame) while the physical layer protocol data units (PPDUs) containing the training symbols (such as NDP) should be transmitted in the mmW links. The beam training using MLO framework requires defining methods and procedures to enable the efficient operation in mmW.

A second potential problem is that, due to the mobility of the non-AP STAs or environmental changes, the best transmit beam used for data transmission may get blocked. In this scenario, the AP or the non-AP STA may initiate a beam recovery procedure to lock on a clean beam and resume the transmission to the non-AP or the AP STA, respectively. The beam recovery procedure may be efficient to minimize the latency and improve the reliability of the connectivity. An efficient beam recovery procedure in the mmW utilizing the MLO framework is an open problem.

In one embodiment, a NDPA frame may be used to announce the transmission of NDPs which may be used for beam training and sector sweeping in mmW links. The NDPA may be sent on the Sub-7 GHz links while the NDP transmission may take place on the mmW links.

In one embodiment, the Sounding Dialog Token field of the NDPA frame may be used to indicate that the NDPA is a UHR variant NDPA or a mmW variant NDPA. One or more bits from B2 to B7 of the Sounding Dialog Token may be used for the identification of the new variants of the NDPA frames (i.e., UHR NDPA or mmW NDPA).

In one embodiment, one or more Special STA Info field(s) may be used in the legacy NDPA design to signal common useful information to all the addressed STAs in the NDPA. Special STA Info field may be indicated by using a Special ID in the AID11 subfield as illustrated in FIG. 4.

FIG. 5 is an exemplary NDPA frame format 500 for UHR and mmW support. In one embodiment, a NDPA control frame may be defined for UHR and mmW operation with a design as shown in FIG. 5. As shown in FIG. 5, the NDPA frame may include a Frame Control field 502, Duration field 504, RA field 506, TA field 508, Common Info field 510, STA Info List field 512, and FCS field 514.

Although the STA Info field shown in FIG. 5 is 4 octets, it may be of a different size which may be indicated in the Common Info field for flexible and efficient use of the NDPA frame in different purposes. The size N of the Common Info field may be 1 or more octets.

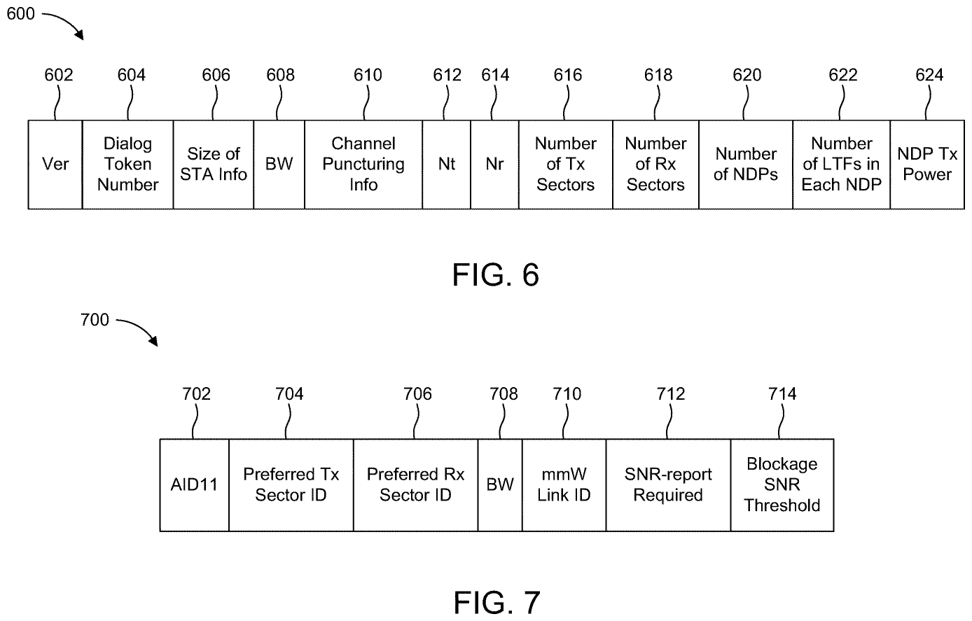

FIG. 6 is an exemplary Common Info field 510 format 600 of the UHR mmW NDPA frame shown in FIG. 5. As shown in FIG. 6, the Common Info field may include a Ver subfield 602, Dialog Token subfield 604, Size of STA info field sub606, BW subfield 608, Channel Puncturing Info subfield 610, Nt subfield 612, Nr subfield 614, Number of Tx Sectors subfield 616, Number of Rx Sectors subfield 618, Number of NDPs subfield 620, Number of LTFs in Each NDP subfield 622, and NDP Tx Power subfield 624. The Common Info field may be defined in a NDPA frame and used to indicate common useful information to all the addressed STAs in the NDPA which may include version information to indicate the version of the NDPA for future compatibility as illustrated in FIG. 5.

The Ver subfield 602 may indicate the version of the NDPA. The Ver subfield 602 may be used for future compatibility where several different variants of the NDPA may be defined in different amendments such that the parsing of the Common Info field, Special STA Info fields, and STA Info fields may be different for different amendments or even different uses of the same amendment. For example, there might be a UHR Sounding Variant of the NDPA which may be used for channel sounding in the Sub-7 GHz band in UHR and another variant which may be used for enhanced sensing or enhanced ranging purposes. There may also be a variant for mmW beam training and sector sweeping and another variant for mmW channel sounding.

TABLE 2
Exemplary Encoding of a 4-bit Ver Subfield
of the Common Info Field in the NDPA Frame

| Ver Subfield | NDPA Variant |
|---|---|
| 0 | UHR Sounding NDPA |
| 1 | UHR Sensing NDPA |
| 2 | mmW (Beam Training/ |
| | Sector Sweep) NDPA |
| 3 | mmW Sounding NDPA |
| 4-15 | Reserved |

The Dialog Token Number subfield 604 may be chosen by the AP to identify the current session of the beam training such that the beam training report would be simply associated to the beam training session.

The Size of STA Info subfield 606 may explicitly indicate the size in octets of the STA Info field in the NDPA frame. The STA Info size may also be implicitly indicated depending on the NDPA frame variant as signaled by the Ver subfield 602.

The BW subfield 608 may indicate the bandwidth of the NDP that will be transmitted on the mmW link a SIFS after the NDPA is transmitted on one or more of the Sub-7 GHz links. The bandwidth of the PPDU carrying the NDPA and is transmitted in the Sub7 GHz band is different from the bandwidth of the NDP PPDU which is transmitted in the mmW link.

The Channel Puncturing Info subfield 610 may indicate the list of punctured channels in the BSS mmW link bandwidth in which the NDP may be transmitted.

The Nt subfield 612 may indicate the number of transmit antennas at the AP.

The Nr subfield 614 may indicate the number of receive antennas at the AP.

The Number of Tx Sectors subfield 616 may indicate the number of transmit sectors in which the AP will support in the downlink, this maps also to the number of formed beams in the downlink.

The Number of Rx Sectors subfield 618 may indicate the number of receive sectors in which the AP will support in the uplink. This subfield also maps to the number of receive beams in the uplink.

The Number of NDPs subfield 620 may indicate the number of transmitted NDPs. The number of NDPs is not necessarily the same as the number of supported sectors. This subfield may indicate the total number of NDPs that will be transmitted in the mmW link. Alternatively, this subfield may indicate the number of NDPs transmitted in each transmit sector.

The Number of LTFs in Each NDP subfield 622 may indicate the number of long training fields in each NDP.

The NDP Tx Power subfield 624 may indicate the combined transmit power over all antennas for the entire BSS mmW bandwidth in which the NDP for beam raining is transmitted, or it may indicate the transmit power per each subchannel of the bandwidth used to transmit the NDP PPDU.

FIG. 7 is an exemplary STA Info field format 700 of the UHR mmW NDPA frame. As shown in FIG. 7, the STA Info field may include an AID11 subfield 702, Preferred Tx Sector ID subfield 704, Preferred Rx Sector ID subfield 706, BW subfield 708, mmW Link ID subfield 710, SNR-report Required subfield 712, and Blockage SNR Threshold subfield 714.

The AID11 subfield 702 may indicate the association ID of the STA which this STA Info field is addressed to.

The Preferred Tx Sector subfield 704 may indicate the ID of the transmit sector that was indicated the preferred transmit sector in the last beam training session.

The Preferred Rx Sector subfield 706 may indicate the ID of the transmit sector that was indicated the preferred receive sector in the last beam training session.

The BW subfield 708 may indicate the bandwidth of the NDP which is to be transmitted on the mmW link a SIFS after the NDPA is transmitted on one or more of the Sub-7 GHz links.

The mmW Link ID subfield 710 may indicate the ID of the mmW link which will be used to transmit the NDP PPDUs used for beam training.

The SNR Report Required subfield 712 may indicate whether the non-AP STA is required to provide SNR measurements for each of the transmit sector and the receive sector pairs.

The Blockage SNR Threshold subfield 714 may indicate the SNR threshold value at which the beam is considered in complete blockage and may not be used for data transmission or data reception and should be reported as a blocked beam.

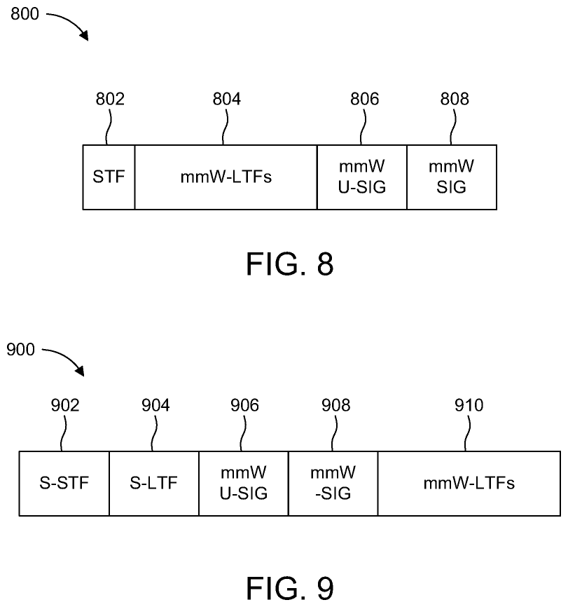

FIG. 8 is an exemplary mmW beam training NDP frame format 800. As shown in FIG. 8, the mmW beam training frame may include a Short Training field (STF) 802, mmW-Long Training fields (LTFs) 804, mmW U-Signal (SIG) field 806, and mmW SIG field 808.

In one embodiment, the beam training NDP PPDU may contain a short preamble with a STF 802 for synchronization, one or more LTFs 804 for beam measurements, and Signal fields to signal beam training information that are essential to identify the beam. The SIG fields may be further divided into mmW U-SIG field 806 and the mmW SIG field 808. The mmW U-SIG field 806 may be used to signal universal information that is not related to beam training or the version of the PHY layer. The mmW SIG field 808 may be used to signal information related to beam training as illustrated in FIG. 8.

FIG. 9 is another exemplary mmW beam training NDP frame format 900. In one embodiment, additionally or alternatively, the beam training NDP PPDU may contain a synchronization STF (S-STF) 902 which may be used for initial synchronization, a synchronization LTF (S-LTF) 904 which may be used for finer synchronization, a mmW U-SIG field 906, a mmW-SIG field 908, and mmW-LTFs 910.

In one embodiment, the number of the LTFs may be signaled in the NDPA frame and in the SIG fields of the beam training NDP PPDU.

In one embodiment, the mmW U-SIG field may contain PHY version independent fields to enable forward compatibility for the future amendments which follows UHR-mmW. The mmW U-SIG field may contain the following subfields as listed in Table 3 below.

TABLE 3
Exemplary Design of mmW U-SIG Field

| Subfield | Description |
|---|---|
| PHY Version | Identifies the version of the current PHY of the |
| | beam training NDP PPDU or the transmitted PPDU |
| Bandwidth | Indicates the bandwidth of the beam training |
| | NDP PPDU or the transmitted PPDU |
| mmW Band | Indicates the band of the mmW link whether |
| | it is 45 GHz or 60 GHz |
| Direction | Indicates the direction of the transmission |
| | (UL or DL) of the beam training NDP PPDU or |
| | the transmitted PPDU |
| BSS Color | Identifies the BSS in which the beam training |
| | NDP PPDU or the transmitted PPDU is transmitted |
| TXOP | Indicates duration information for the NAV |
| | setting and protection of the TXOP |
| PPDU Type | Indicates the type of the PPDU whether a beam |
| | training NDP PPDU or other type of PPDU |
| Channel | Provides a list of the Punctured Channels in |
| Puncturing | the bandwidth of the transmitted beamforming |
| Info | NDP PPDU or the transmitted PPDU. |
| mmW-SIG MCS | Indicates the MCS used for modulating the mmW |
| | SIG field |
| Number of mmW- | Indicates the number of the OFDM Symbols of |
| SIG Symbols | the mmW-SIG field |

In one embodiment, the mmW-SIG field may contain beam training information. The mmW-SIG field may contain the following subfields as listed in Table 4 below.

TABLE 4
Exemplary Design of mmW-SIG Field

| Subfield | Description |
|---|---|
| Number | Indicates the total number of supported sectors (beams) |
| of Sectors | by the AP. |
| NDP ID | Indicates the ID of the current NDP, this subfield is set |
| | to the ID of the NDP minus 1 |
| Sector ID | Indicates the ID of the Sector in which this NDP is |
| | currently transmitted, this subfield is set to the ID |
| | of the Sector minus 1 |
| Antenna ID | Indicates the ID of the Antenna by which this NDP is |
| | currently transmitted, this subfield is set to the ID |
| | of the Antenna minus 1 |
| LTF Size | Indicates the size of the LTF as 1xLTF, 2xLTF or 4xLTF |
| | and indicates the Guard Interval (GI) for the LTF symbols |
| Number | Indicates the number of LTFs in the currently transmitted |
| of LTFs | NDP |

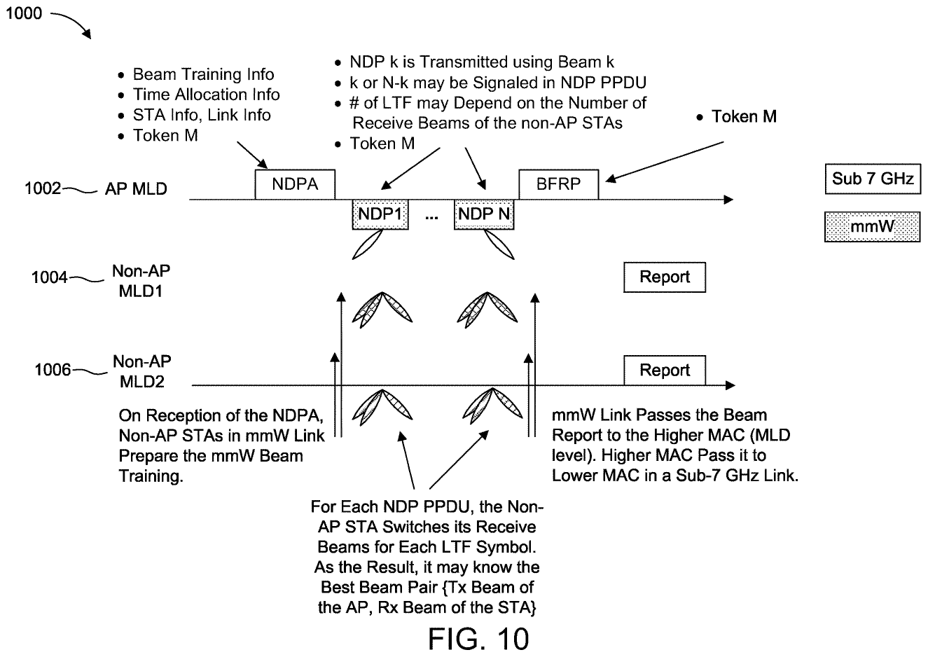

FIG. 10 illustrates an exemplary frame exchange sequence of the overall training procedure 1000. As shown in FIG. 10, in one embodiment, one AP and one or more non-AP STAs may participate in one or more beam training sessions. AP 1002 may participate as the initiator of the beam training session and the non-AP STAs 1004 and 1006 may participate as the responders of the beam training session. Different control frames or beam training PPDUs of the beam training session may be sent on different links. For example, the Sub-7 GHz links may be used for sending control frames and mmW links may be used for transmitting beam training PPDUs.

In one embodiment, the AP that initiates the beam training session and is the holder of the current TXOP, may transmit the NDPA in one or more of the Sub-7 GHz band links in the TXOP which is immediately claimed by this AP. The NDPA may be transmitted in a UHR PPDU or any legacy PPDU. The bandwidth of the PPDU carrying the NDPA may be indicated in the SIG field of the PPDU carrying the NDPA. The bandwidth indicated in the Common Info field, the Special STA Info field(s), or in the STA Info fields of the NDPA refers to the bandwidth of the beam training NDP PPDU which will be transmitted immediately after the NDPA.

In one embodiment, the AP that initiates the beam training session and is the holder of the current TXOP may switch to one or more links in the mmW band and transmit the beam training NDP PPDU a SIFS after the NDPA is transmitted on the Sub-7 GHz band. The NDP PPDU may cover the entire bandwidth of the mmW link as indicated in the Common Info field, the Special STA Info field(s), or in the STA Info fields of the NDPA. The NDP PPDU may have punctured subchannels within the bandwidth of the PPDU which may be indicated also in the NDPA. One or more NDP PPDU(s) may be transmitted in each sector of the available sectors and each NDP is identified by the NDP ID, the Sector ID and the Antenna ID. The number of transmitted NDP PPDUs may be greater than or equal to the number of sectors. The AP STA may sweep to the next sector and transmit the corresponding NDP(s) intended for transmission in this sector. The NDPs may be SIFS separated or separated with any other Inter-Frame Space (IFS). Each NDP may be transmitted with a transmit power equal to the NDP Tx Power as indicated in the NDPA immediately preceding the NDP transmission. The number of LTFs in each NDP PPDU may be indicated in the NDPA and may be greater than or equal to the largest number of receive sectors/beams supported by the non-AP STAs participating in the beam training session.

In one embodiment, the AP that initiates the beam training session and is the holder of the current TXOP may switch back to the Sub-7 GHz link and transmit the BFRP or any other Trigger frame or Control frame that is designed to trigger feedback transmission from the non-AP STAs in the uplink.

In one embodiment, one or more non-AP STAs may participate in the beam training session as responders such that each non-AP STA may be addressed by one or more STA Info field in the NDPA sent from the AP who is the initiator of the beam training session.

In one embodiment, the non-AP STA receives the NDPA sent by the AP on the Sub-7 GHz link and parses the Dialog Token field and/or the Common Info field and/or the Special STA Info field(s) to detect if the NDPA is initiating a beam training session and to gather all the information signaled in the mentioned fields to prepare for the beam training session.

In one embodiment, the non-AP STA may parse the STA Info list searching for a STA Info field that is addressed to itself by examining the AID11. If the non-AP STA AID matches one or more STA Info field(s) in the STA Info list, the non-AP starts to parse the STA Info field(s) and prepare for the beam training session. Otherwise, if the non-AP STA AID does not match any of the AID11 of the STA Info fields in the STA Info list, the non-AP STA may stop decoding the NDPA and may enter in a dose mode after setting its NAV counter(s).

In one embodiment, if the non-AP STA is addressed in the STA info list of the immediately sent NDPA on the Sub-7 GHz link, the non-AP STA may switch to the mmW link(s) and prepare to receive the NDP PPDUs which may be sent on the mmW link as indicated in the STA Info field.

In one embodiment, the non-AP STA may switch its receive beam for each LTF symbol or a group of LTF symbols contained in the received NDP PPDU which is transmitted in one of the transmit sectors/beams of the AP. The non-AP may then measure the SNR, the RSSI or any other physical measurement of the received LTF to represent the strength or the quality of the received signal. The non-AP STA may also measure the average SNR, the average RSSI or the average of any other physical measurement of the received group of LTFs to represent the strength or the quality of the received signal. The non-AP STA may average the measurements over multiple NDP PPDUs if the AP transmits more than one NDP PPDU in the same sector/beam. By performing this receive procedure, each non-AP should have a measure of the signal strength or signal quality of each pair of transmit beam and receive beam.

In one embodiment, if the SNR Report Required subfield in the STA Info field addressed to this non-AP STA is set to 0, the non-AP STA may be required to prepare a full report for all transmit sector and receive sector combinations, otherwise, the non-AP STA may only prepare a report for the best transmit sector and receive sector pair.

In one embodiment, if the measured SNR of a given transmit beam and receive beam combination is less than the threshold value indicated in the Blockage SNR Threshold subfield of the STA Info field, then this transmit beam may be considered in a full blockage state with respect to the considered receive beam and a special value in the beam training report may indicate this case. In another embodiment, the non-AP STA may only prepare a beam training report for the transmit beam and receive beam pairs which have a SNR value greater than or equal to the Blockage SNR Threshold.

In one embodiment, the non-AP STA may prepare a beam training report and send it back to the AP as a response to a beam training trigger frame which is sent to solicit the beam training report. Both the beam training trigger frame and the solicited beam training report may be sent on the Sub-7 GHz links.

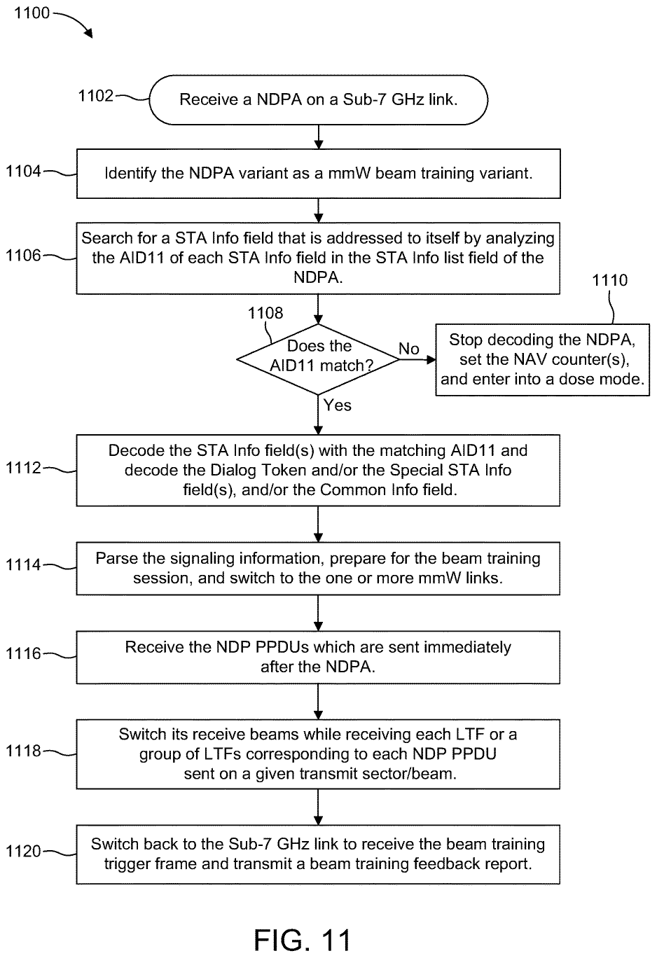

FIG. 11 is a flowchart illustrating an exemplary beam training procedure 1100. In one embodiment, the beam training procedure explained above may be illustrated by the flowchart depicted in FIG. 11.

At 1102, a non-AP STA may receive an NDPA, from an AP, on a Sub-7 GHz link.

At 1104, the non-AP STA may identify the NDPA variant as the mmW beam training variant.

At 1106, the non-AP STA may search for an STA Info field that is addressed to the non-AP STA by examining the AID11 field of each STA Info field in the STA Info list of the NDPA.

At 1108, the non-AP STA may determine if the non-STA AID matches any of the AID11 of the STA info fields in the STA Info list. At 1110, if the AID11 does not match, the non-AP STA may stop decoding the NDPA, set one or more NAV counters, and enter in a dose mode.

At 1112, if the AID11 does match, the non-AP STA may decode the one or more STA Info fields with the matching AID11 and decode the Dialog Token field, and/or the Special STA info field, and/or the Common Info field.

At 1114, the non-AP STA may parse the signaling information, prepare for the beam training session, and switch to the one or more mmW links.

At 1116, the non-AP STA may receive the NDP PPDUs which are sent immediately after the NDPA is sent by the AP.

At 1118, the non-AP STA may switch its receive beam for each LTF symbol or a group of LTF symbols contained in the received NDP PPDU which is transmitted in one of the transmit sectors/beams of the AP. The non-AP may then measure the SNR, the RSSI or any other physical measurement of the received LTF to represent the strength or the quality of the received signal. The non-AP STA may also measure the average SNR, the average RSSI or the average of any other physical measurement of the received group of LTFs to represent the strength or the quality of the received signal. The non-AP STA may average the measurements over multiple NDP PPDUs if the AP transmits more than one NDP PPDU in the same sector/beam. By performing this receive procedure, each non-AP should have a measure of the signal strength or signal quality of each pair of transmit beam and receive beam.

At 1120, the non-AP STA may switch back to the Sub-7 GHz link to receive the beam training trigger frame and transmit, back to the AP, a beam training feedback report.

In one embodiment, the beam training for mmW links may consider a time structure for the transmission where time slots may be defined in which the transmission of the NDP training PPDUs take place.

In one embodiment, additionally or alternatively a Common Info field may be defined in a NDPA frame and used to indicate common useful information to all the addressed STAs in the NDPA considering time-slotted transmission.

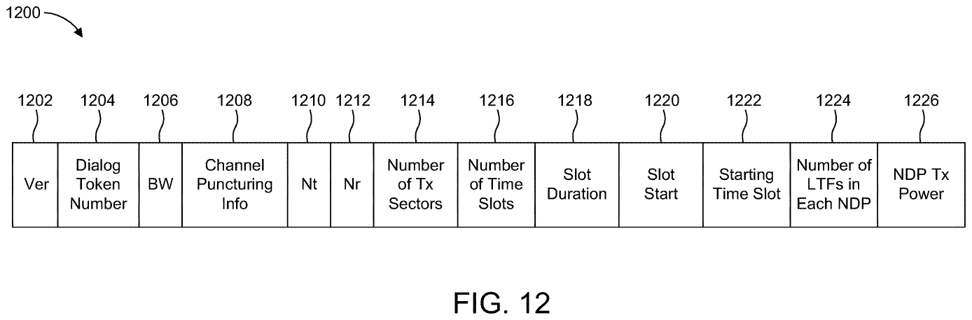

FIG. 12 is an exemplary additional, or alternate design of a Common Info field format 1200. The subfields of the Common Info field in FIG. 12 may come with any possible combination of the Common Info frame format shown in FIG. 6.

As shown in FIG. 12, an additional, or alternate design of a Common Info field may include a Ver subfield 1202, Dialog Token subfield 1204, BW subfield 1206, Channel Puncturing Info subfield 1208, Nt subfield 1210, Nr subfield 1212, Number of Tx Sectors subfield 1214, Number of time slots subfield 1216, slot duration subfield 1218, Slot Start subfield 1220, Starting Time Slot subfield 1222, Number of LTFs in Each NDP subfield 1224, and NDP Tx Power subfield 1226.

The Number of Time Slots subfield 1216 may indicate the number of time slots in which the beam training procedure may take place. Each time slot may contain one or more NDP PPDUs which may be used for beam training. The transmission of the first NDP PPDU in each time slot may take place exactly at the start of the time slot boundary. The subsequent NDP PPDUs if any, may be transmitted a SIFS after the first NDP PPDU and a SIFS separated from each other. The NDP PPDUs may also be transmitted with any Inter-Frame Spacing separation.

The Slot Duration subfield 1218 may indicate the duration of each time slot. This duration may be expressed in time units (such as u seconds) or it may be expressed in number of OFDM symbols.

The Slot Start subfield 1220 may indicate the point in time where the first time slot in the mmW link starts (TO). This point may be indicated relative to the end of the NDPA frame. In one example, the slot start point TO may be indicated to be a SIFS or any other IFS occurring after the end of the NDPA frame.

The Starting Time Slot subfield 1222 may indicate which time slot will be the one where the first NDP PPDU may be transmitted. In one example, the AP may choose to defer the transmission of the NDP PPDUs for one or more time slot starting at the first time slot and start to transmit the first NDP PPDU in the Starting Time Slot.

Additionally, in one embodiment, the mmW-SIG field (as describe in FIG. 8 above), may contain time slot information subfields as listed in Table 5 below in addition to the subfields listed in Table 4.

TABLE 5
Exemplary Design of the mmW Sig Field

| Subfield | Description |
|---|---|
| Number of | Indicates the total number of time slots that will |
| Time Slots | be used in this beam training session. |
| Time | Indicates ID of the time slot during which this NDP |
| Slot ID | PPDU is transmitted |
| First NDP | Indicates whether this is the first NDP PPDU |
| | transmitted in the current time slot or not. |
| Last NDP | Indicates whether this is the last NDP PPDU |
| | transmitted in the current time slot or not. |

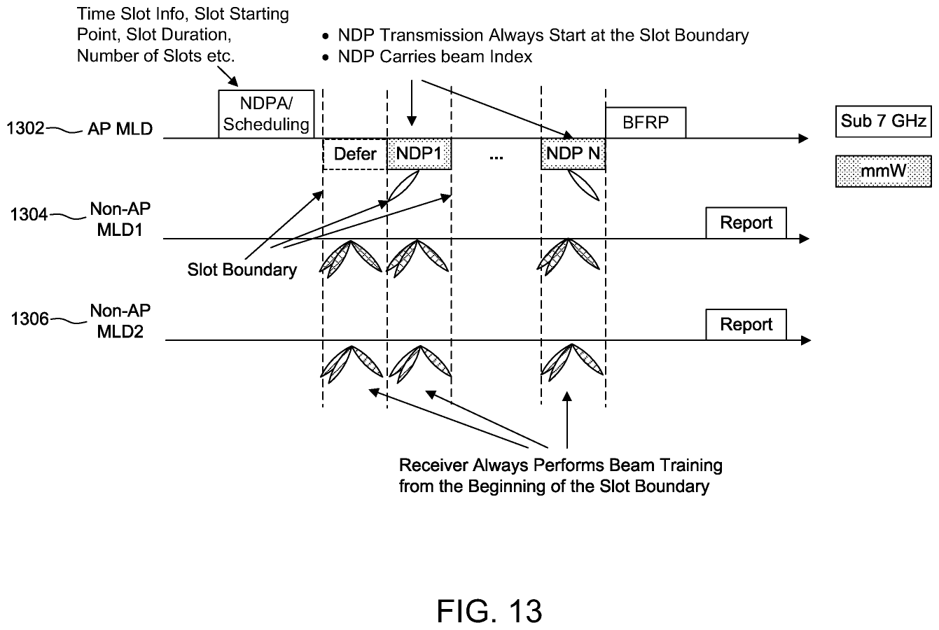

FIG. 13 illustrates an exemplary frame exchange sequence of the timeslot based beam training procedure. As shown in FIG. 13, In one embodiment, one AP and one or more non-AP STAs may participate in one or more beam training sessions as depicted in FIG. 13. AP 1302 may participate as the initiator of the beam training session and non-AP STAs 1304 and 1306 may participate as the responders of the beam training session. The control frames of the beam training session may be sent on the Sub-7 GHz links while the beam training NDP PPDUs may be sent on the mmW links.

In one embodiment, the AP that initiates the beam training session and is the holder of the current TXOP may transmit the NDPA in one or more of the Sub-7 GHz band links in the TXOP which is immediately claimed by this AP. The NDPA may be transmitted in a UHR PPDU or any legacy PPDU. The bandwidth of the PPDU carrying the NDPA may be indicated in the SIG field of the PPDU carrying the NDPA. The bandwidth indicated in the Common Info field, the Special STA Info field(s), or in the STA Info fields of the NDPA refers to the bandwidth of the beam training NDP PPDU which will be transmitted immediately after the NDPA.

In one embodiment, the AP that initiates the beam training session and is the holder of the current TXOP may switch to one or more links in the mmW band and transmit the beam training NDP PPDU. The AP may follow a time slot-based structure in which the transmission of the beam training NDP PPDU only takes place within a time slot.

In one embodiment, the AP that initiates the beam training session and is the holder of the current TXOP may indicate the point in time where the first time slot starts (TO) in the Slot Start subfield of the Common Info field in the NDPA frame immediately preceding the transmission of the beam training NDPs. In one example, the TO point may be indicated as a SIFS after the end of the NDPA frame.

In one embodiment, the AP that initiates the beam training session and is the holder of the current TXOP may choose to defer the transmission in the first time slot of the set of time slots which will be used to send the beam training NDP PPDUs.

In one embodiment, the AP may choose to send one or more NDP PPDUs in the same time slot. The NDP PPDUs transmitted within a time slot may be separated from each other by a SIFS or any IFS. The NDP PPDU may cover the entire bandwidth of the mmW link as indicated in the Common Info field, the Special STA Info field(s), or in the STA Info fields of the NDPA. The NDP PPDU may have punctured subchannels within the bandwidth of the PPDU which may be indicated also in the NDPA. One or more NDP PPDU(s) may be transmitted in each sector of the available sectors and each NDP is identified by the NDP ID, the Sector ID and the Antenna ID. The number of transmitted NDP PPDUs may be greater than or equal to the number of sectors. The AP STA sweeps to the next sector and transmits the corresponding NDP(s) intended for transmission in this sector. The transmission of the NDP PPDUs intended for one transmit sector may take place in one or more time slots. Each NDP may be transmitted with a transmit power equal to the NDP Tx Power as indicated in the NDPA immediately preceding the NDP transmission. The number of LTFs in each NDP PPDU may be indicated in the NDPA and may be greater than or equal to the largest number of receive sectors/beams supported by the non-AP STAs participating in the beam training session.

In one embodiment, the AP that initiates the beam training session and is the holder of the current TXOP may switch back to the Sub-7 GHz link and transmit the BFRP or any other Trigger frame or Control frame that is designed to trigger feedback transmission from the non-AP STAs in the uplink. The transmission of the trigger frame to solicit the feedback may start at the ending boundary of the last time slot of the group of time slots used for the mmW beam training session.

In one embodiment, one or more non-AP STAs may participate in the beam training session as responders such that each non-AP STA may be addressed by one or more STA Info field in the NDPA sent from the AP who is the initiator of the beam training session.

In one embodiment, the non-AP STA may receive the NDPA sent by the AP on the Sub-7 GHz link and parses the Dialog Token field and/or the Common Info field and/or the Special STA Info field(s) to detect if the NDPA is initiating a beam training session and to gather all the information signaled in the mentioned fields to prepare for the beam training session and to setup the time structure in which the time slots of the beam training session are defined and signaled in the NDPA frame.

In one embodiment, the non-AP STA may parse the STA Info list searching for a STA Info field that is addressed to itself by looking at the AID11. If the non-AP STA AID matches one or more STA Info field(s) in the STA Info list, the non-AP starts to parse the STA Info field(s) and prepare for the beam training session. Otherwise, if the non-AP STA AID does not match any of the AID11 of the STA Info fields in the STA Info list, the non-AP STA may stop decoding the NDPA and may enter in a dose mode after setting its NAV counter(s).

In one embodiment, if the non-AP STA is addressed in the STA info list of the immediately sent NDPA on the Sub-7 GHz link, the non-AP STA may switch to the mmW link(s) and prepare to receive the NDP PPDUs which may be sent on the mmW link as indicated in the STA Info field. The non-AP STA may start a counter at point TO which indicates the starting boundary of the first time slot. The non-AP may start the reception of the NDP PPDUs at the starting boundary of the Starting Time Slot which indicates the time slot in which the first NDP PPDU transmission may occur. The Starting Time slot may be different from the First Time Slot if the AP chooses to defer the NDP PPDU transmission in the first one or more time slots starting at TO.

In one embodiment, the non-AP STA may switch its receive beam for each LTF symbol or a group of LTF symbols contained in the received NDP PPDU which is transmitted in one of the transmit sectors/beams of the AP in one of the time slots of the time structure. The non-AP may then measure the SNR, the RSSI or any other physical measurement of the received LTF to represent the strength or the quality of the received signal. The non-AP STA may also measure the average SNR, the average RSSI or the average of any other physical measurement of the received group of LTFs to represent the strength or the quality of the received signal. The non-AP STA may average the measurements over multiple NDP PPDUs if the AP transmits more than one NDP PPDU in the same sector/beam in the same time slot or over multiple time slots. By performing this receive procedure, each non-AP may have a measure of the signal strength or signal quality of each pair of transmit beam and receive beam.

In one embodiment, the non-AP STA may prepare a beam training report and send it back to the AP as a response to a beam training trigger frame which is sent to solicit the beam training report. Both the beam training trigger frame and the solicited beam training report may be sent on the Sub-7 GHz link(s).

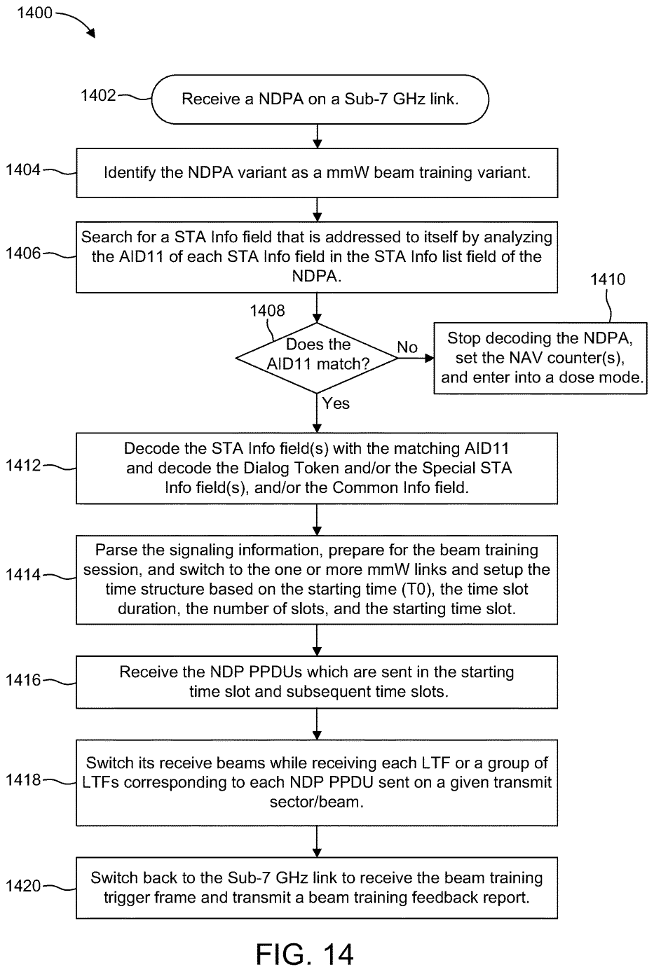

FIG. 14 is a flowchart illustrating an exemplary timeslot-based beam training procedure. In one embodiment, the beam training procedure explained above may be illustrated by the flowchart depicted in FIG. 14 considering the time structure defined by the time slots which are used to manage the transmission of the NDP PPDUs.

At 1402, the non-AP STA may receive an NDPA, from an AP, on a Sub-7 GHz link.

At 1404, the non-AP STA may identify the NDPA variant as the mmW beam training variant.

At 1406, the non-AP STA may search for an STA Info field that is addressed to the non-AP STA by examining the AID11 field of each STA Info field in the STA Info list of the NDPA.

At 1408, the non-AP STA determines if the non-STA AID matches any of the AID11 of the STA info fields in the STA Info list. At 1410, if the AID11 does not match, the non-AP STA may stop decoding the NDPA, set one or more NAV counters, and enter in a dose mode.

If the AID11 does match, at 1412, the non-AP STA may decode the one or more STA Info fields with the matching AID11 and decode the Dialog Token field, and/or the Special STA info field, and/or the Common Info field.

At 1414, the non-AP STA may parse the signaling information, prepare for the beam training session, and switch to the one or more mmW links and setup the time structure based on the starting time (TO), the time slot duration, the number of slots, and the starting time slot.

At 1416, the non-AP STA may receive the NDP PPDUs which are sent in the starting time slot and subsequent time slots.

At 1418, the non-AP STA may switch its receive beam for each LTF symbol or a group of LTF symbols contained in the received NDP PPDU which is transmitted in one of the transmit sectors/beams of the AP. The non-AP may then measure the SNR, the RSSI or any other physical measurement of the received LTF to represent the strength or the quality of the received signal. The non-AP STA may also measure the average SNR, the average RSSI or the average of any other physical measurement of the received group of LTFs to represent the strength or the quality of the received signal. The non-AP STA may average the measurements over multiple NDP PPDUs if the AP transmits more than one NDP PPDU in the same sector/beam. By performing this receive procedure, each non-AP should have a measure of the signal strength or signal quality of each pair of transmit beam and receive beam.

At 1420, the non-AP STA may switch back to the Sub-7 GHz link to receive the beam training trigger frame and transmit, back to the AP, a beam training feedback report.

In one embodiment, the beam training methods and procedures employed to identify the best transmit beam and receive beam pair for the operation in the downlink (transmission from AP STA to non-AP STA) as explained above may be used reciprocally as the preferred beam pairs for the transmission in the uplink (transmission form the non-AP STA to the AP STA). The best transmit beam in the downlink transmission from the AP to the non-AP STA may be used as the best receive beam in the uplink transmission from the non-AP STA to the AP and the best receive beam in the downlink transmission from the AP to the non-AP STA may be used as the best transmit beam in the uplink transmission form the non-AP STA to the AP STA.

In one embodiment, the beam failure may be triggered by the event when the number of consecutive ACKs or Block ACKs that are not received by the transmitter of the PPDU sent to the same STA is equal or larger than N, N is a system parameter. N may be carried in the beacon or other management frames. For example, if the transmitter of the PPDU, the AP, does not receive the ACKs or Block ACKs for N consecutive PPDU transmissions to the same STA, then the AP may determine it is a beam failure between AP and the recipient STA.

In one embodiment, the AP STA may initiate the beam recovery procedure with one or more non-AP STAs after detecting the beam failure. In one example, the AP may detect the beam failure by observing the Bit Error Rate (BER) or the Packet Error Rate (PER) and trigger a beam failure event when the BER or the PER exceeds a given value. The beam recovery procedure may be initiated pairwise with one non-AP STA at a time, or it may be initiated with more than one non-AP STAs concurrently. In another embodiment, the beam recovery procedure may be initiated by the non-AP STA(s).

In one embodiment, the non-AP STA may continuously report a physical layer measurement such as the RSSI or the SNR of the data packets sent over a given transmit beam and receive beam pair. The AP STA may then declare a beam failure if this measurement falls below a given threshold. The AP may also count the number of times the beam failure event is detected and initiate a beam recovery procedure if the number of beam failures exceeds a certain preset value. The threshold of the RSSI or SNR at which a beam failure event is detected may be set as a static value which is announced in a beacon frame or any other management frame. The threshold of the RSSI or SNR at which a beam failure event is detected may also be set dynamically using the NDPA frame or any control frame which initiates the beam training in the first place. The number of beam failure events at which a beam recovery procedure is to be initiated may be set as a static value which is announced in a beacon frame or any other management frame. The number of beam failure events at which a beam recovery procedure to be initiated may also be set dynamically using the NDPA frame or any control frame which initiates the beam training in the first place.

In one embodiment, an information element named Beam Recovery element may be added to the beacon frame, association request frame, association response frame, reassociation request frame, reassociation response frame, probe request frame, probe response frame, or any other management frame used to manage the operation in a BSS or a Multi AP as the exemplary indication in the beacon frame in Table 6 below.

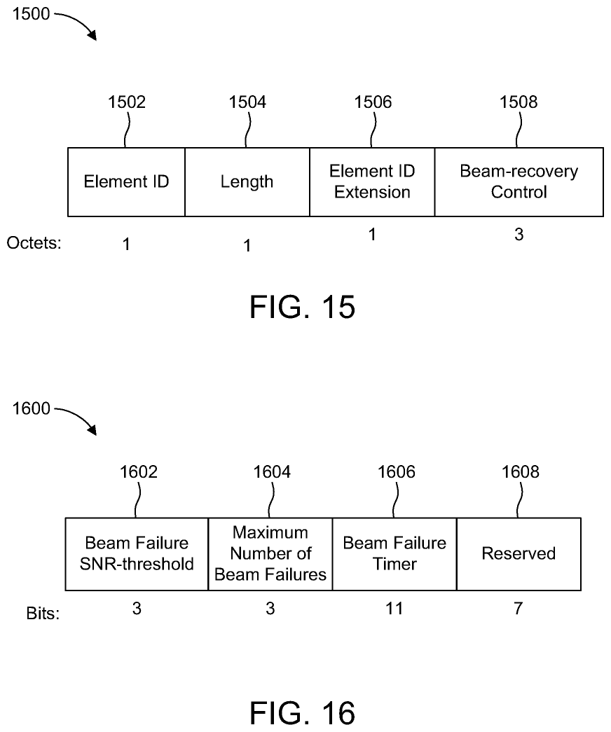

FIG. 15 is an exemplary Beam Recovery element format 1500. In one embodiment, the Beam Recovery element may be used to statically configure of the beam recovery procedure. As shown in FIG. 15, the Beam Recovery element may include an Element ID field 1502, Length field 1504, Element ID Extension field 1506, and Beam-recovery Control field 1508.

FIG. 16 is an exemplary Beam-Recovery Control field format 1600 as shown in 1508. As shown in FIG. 16, the Beam-Recovery Control field may include a Beam Failure SNR Threshold subfield 1602, Maximum Number of Beam Failures subfield 1604, Beam Failure Timer subfield 1606, and reserved subfield 1608.

The Beam Failure SNR Threshold subfield 1602 may signal the SNR level at which the beam may be considered in a failure state. An Exemplary encoding of this subfield is indicated in Table 7 below.

The Maximum Number of Beam Failures subfield 1604 may signal the number of beam failure events at which the beam would be considered unreliable and at which a STA would initiate a beam recovery procedure. An Exemplary encoding of this subfield is indicated in Table 8 below.

The Beam Failure Timer subfield 1606 may signal a timer initial value which is initialized and starts to count down once a beam failure event is detected and if the timer reaches 0 before another beam failure happens, the counter counting the number of beam failure events may be reset to 0.

TABLE 6
Beacon Frame Body

| Order | Information | Notes |
|---|---|---|
| <Last | Beam | The Beam Recovery element is present |
| assigned + 1> | Recovery | if dot11BeamRecoveryImplemented is |
| | | true; otherwise it is not present |

TABLE 7
Exemplary Encoding of the Beam Failure SNR Threshold Subfield

| Beam Failure SNR- | SNR-Threshold |
|---|---|
| Threshold Subfield | Value (dB) |
| 000 | −10 |
| 001 | −8 |
| 010 | −6 |
| 011 | −4 |
| 100 | −2 |
| 101 | 0 |
| 110 | 2 |
| 111 | 4 |

TABLE 8
Exemplary Encoding of the Maximum
Number of Beam Failures Subfield

| Maximum Number | Maximum Number |
|---|---|
| of Beam | of Beam |
| Failures Subfield | Failures Value |
| 000 | 4 |
| 001 | 8 |
| 010 | 16 |
| 011 | 32 |
| 100 | 64 |
| 101-111 | Reserved |

In one embodiment, the NDPA employed to initiate a beam training session may also signal the configuration of the beam recovery procedure.

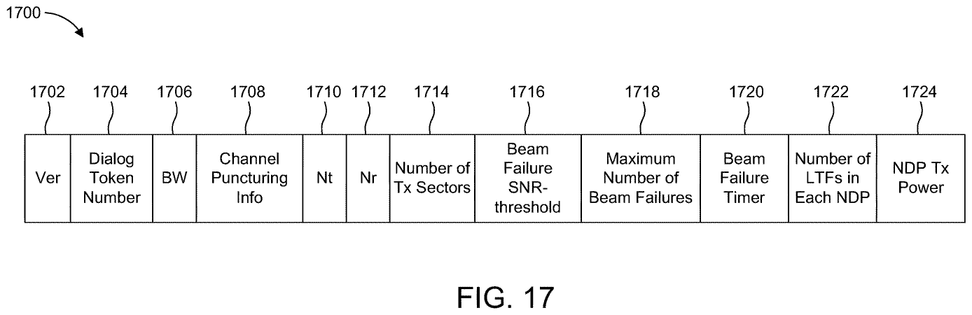

FIG. 17 is an exemplary Common Info field frame format 1700 for Dynamic Configuration of Beam Recovery Procedure. The Common Info field frame for Dynamic Configuration of Beam Recovery Procedure may include a Ver subfield 1702, Dialog Token subfield 1704, BW subfield 1706, Channel Puncturing Info subfield 1708, Nt subfield 1710, Nr subfield 1712, Number of Tx Sectors subfield 1714, Beam Failure SNR-threshold 1716, Maximum Number of Beam Failures 1718, Beam Failure Timer 1720, Number of LTFs in Each NDP subfield 1722, and NDP Tx Power subfield 1724.

As shown in FIG. 17, the Common Info field, the Special STA Info field(s), or the STA Info field(s) may contain one or more of the subfields Beam Failure SNR-Threshold, Maximum Number of Beam Failures and Beam Failure Timer which may be used to dynamically configure the beam recovery procedure.

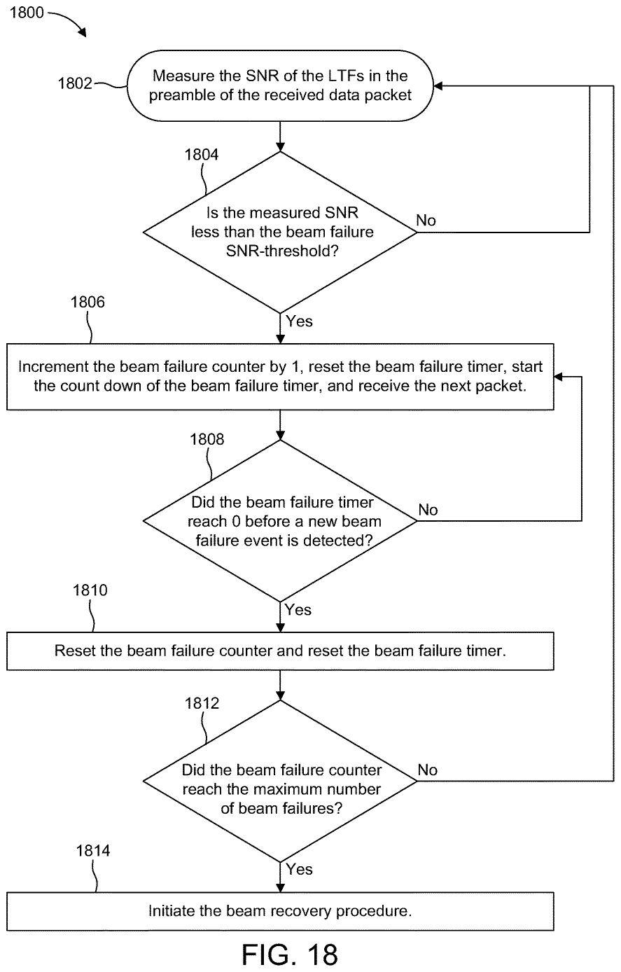

In one embodiment, each time a beam failure occurs, the AP or the non-AP STA may increment a counter of the number of the beam failure events by 1 and reset the Beam Failure Timer. If the Beam Failure Timer reaches 0 before a new beam failure is detected, the Beam Failure Counter is reset to 0. If the Beam Failure Counter reaches the Maximum Number of Beam Failures, the AP initiates the beam recovery procedure. FIG. 18 illustrates an exemplary beam failure detection procedure.

In one embodiment, the beam recovery procedure may be initiated by the AP STA after detecting beam failure. The beam recovery procedure may start by sending a mmW beam training NDPA on the Sub-7 GHz link followed after a SIFS by a series of NDP PPDUs transmitted on the mmW link which may follow the same procedure employed for initial beam training. The AP may then send a trigger frame to solicit the beam training report on the Sub-7 GHz.

In one embodiment, the NDPA sent to initiate the beam recovery may contain a STA Info field addressed to the non-AP STA which the beam connecting it to the AP is declared as in a beam failure state. The NDPA may also contain STA Info fields for other non-STAs who are in initial beam training, or their beams are declared as in a beam failure state.

In one embodiment, the non-AP STA may send a frame to AP indicating the beam failure in lower band link after the beam failure is triggered in the MAC layer of the non-AP STA. Then this signal may be carried in the control frame, e.g., ACK or Block frame, or A-control field of the management frame or data frame.

FIG. 18 is a flowchart illustrating an exemplary beam failure detection procedure.

At 1802, the non-AP STA may measure the SNR of the LTFs in the preamble of the received data packet.

At 1804, the non-AP STA may determine whether the measured SNR is less than a beam failure SNR-threshold. If the measured SNR is not less than the beam failure SNR-threshold, the non-AP STA may return to 1804 and continue to measure the SNR.

If the measured SNR is less than the beam failure SNR-threshold, at 1806, the non-AP STA may increment a Beam Failure Counter by 1, reset a Beam Failure timer, start the timer on a beam failure timer, and receive the next packet.

At 1808, the non-AP STA may determine whether the Beam Failure Timer reaches 0 prior to a new beam failure event being detected. If the Beam Failure Timer does not reach 0, the non-AP STA returns to 1806 and increments the Beam Failure Counter by 1 in the event that another measured SNR is less than the beam failure SNR-threshold.

At 1810, if the Beam Failure Timer reaches 0, the non-AP STA may reset the Beam Failure Counter and reset the Beam Failure Timer.

At 1812, the non-AP STA may determine whether the Beam Failures Counter reaches the maximum number of beam failures. If the Beam Failures Counter did reach the maximum number of beam failures, at 1814 the non AP-STA may initiate the beam recovery procedure. If the Beam Failures Counter did not reach the maximum number of beam failures, the non-AP STA may return to 1802.

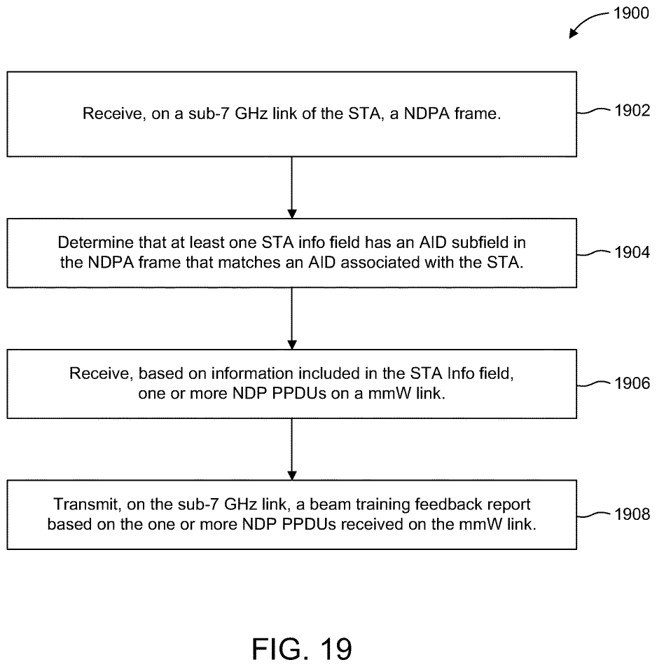

FIG. 19 is a is a flowchart illustrating an exemplary beam training procedure 1900. In one embodiment, the beam training procedure explained above may be illustrated by the flowchart depicted in FIG. 19.

At 1902, a non-AP STA may receive, on a sub-7 GHz link of the STA, a NDPA. The NDPA may include information to initiate a millimeter wave (mmW) beam training process. At 1904, the non-AP STA may determine that at least one STA info field has an association ID (AID) subfield in the NDPA frame that matches an AID associated with the STA. At 1906, the non-AP STA may determine, based on the matched AID, STA subfield information corresponding to a mmW beam training session. At 1908, the non-AP STA may receive, based on the STA subfield information, one or more NDP PPDUs on a mmW link. At 1910, the non-AP STA may transmit, on a sub-7 GHz link, a beam training feedback report based on the one or more NDP PPDUs received on the mmW link.

Although the features and elements of the present invention are described in the preferred embodiments in particular combinations, each feature or element may be used alone without the other features and elements of the preferred embodiments or in various combinations with or without other features and elements of the present invention.

Although the solutions described herein consider 802.11 specific protocols, it is understood that the solutions described herein are not restricted to this scenario and are applicable to other wireless systems as well. Although SIFS is used to indicate various inter frame spacing in the examples of the designs and procedures, all other inter frame spacing such as RIFS, AIFS, DIFS or other agreed time interval could be applied in the same solutions. Although sub-7 GHz link/band is used to refer to a link in MLO system where the control/management frames may be transmitted for mmW link/band, it may be replaced by a more general term such as lower frequency link/band.

Although the first field/subfield/element/subelement may be defined in a second field/subfield/element/subelement/frame, the first field/subfield/element/subelement may be carried in other fields/subfields/elements/subelements/frames to indicate the same information.

Although the above describes a NDPA frame transmitted over a sub-7 GHz link to schedule a beam training in mmW link, the NDPA frame may be replaced or renamed by other management frame or control frame with the similar information and signaling disclosed herein.

Although the above describes a NDP PPDU/frame transmitted over a mmW link, the NDP PPDU/frame may be replaced or renamed by another management frame or control frame with the similar design and signaling disclosed herein.

A Long Training Field (LTF) may be any type of predefined sequences that are known at both the transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a station (STA), the method comprising:
receiving, on a sub-7 GHz link of the STA, a null data packet (NDP) announcement (NDPA) frame, wherein the NDPA includes information to initiate a millimeter wave (mmW) beam training process;
determining that at least one STA Info field included in the NDPA frame includes an association ID (AID) subfield that matches an AID associated with the STA;
receiving, based on information included in the STA Info field, one or more NDP physical layer protocol data units (PPDUs) on a mmW link; and
transmitting, on the sub-7 GHz link, a beam training feedback report based on the one or more NDP PPDUs received on the mmW link.

2. The method of claim 1, wherein the NDPA includes a Common Info field.

3. The method of claim 2, wherein the Common Info field includes at least one of a Ver subfield, a Dialog Token Number subfield, a Size of STA Info subfield, a BW subfield, a Channel Puncturing Info subfield, an Nt subfield, an Nr subfield, a Number of Tx Sectors subfield, a Number of Rx Sectors subfield, a Number of NDPs subfield, a Number of LTFs in each NDP subfield, or an NDP Tx Power subfield.

4. The method of claim 1, wherein the STA Info field includes at least one of a AID11 subfield, a Preferred Tx Sector ID subfield, a Preferred Rx Sector ID subfield, a BW subfield, a mmW Link ID subfield, a SNR-report Required subfield, or a Blockage SNR Threshold subfield.

5. The method of claim 1, wherein the one or more NDP PPDUs includes at least one of a mmW U-SIG field or mmW-SIG field.

6. The method of claim 5, wherein the mmW U-SIG field includes at least one of a PHY Version subfield, a Bandwidth subfield, a mmW Band subfield, a Direction subfield, a BSS color subfield, a TXOP subfield, a PPDU Type subfield, a Channel Puncturing Info subfield, a mmW-SIG MCS subfield, or a Number of mmW-SIG Symbols subfield.

7. The method of claim 5, wherein the mmW-SIG field includes at least one of a Number of Sectors subfield, a NDP ID subfield, a Sector ID subfield, an Antenna ID subfield, a LTF Size subfield, or a Number of LTFs subfield.

8. A station (STA) comprising:
one or more transceivers and a processor configured to:
receive, on a sub-7 GHz link of the STA, a null data packet (NDP) announcement (NDPA) frame, wherein the NDPA includes information to initiate a millimeter wave (mmW) beam training process;
determine that at least one STA Info field included in the NDPA frame has an association ID (AID) subfield that matches an AID associated with the STA;
receive, based on information included in the STA Info field, one or more NDP physical layer protocol data units (PPDUs) on a mmW link; and
transmit, on the sub-7 GHz link, a beam training feedback report based on the one or more NDP PPDUs received on the mmW link.

9. The STA of claim 8, wherein the NDPA includes a Common Info field.

10. The STA of claim 9, wherein the Common Info field includes at least one of a Ver subfield, a Dialog Token Number subfield, a Size of STA Info subfield, a BW subfield, a Channel Puncturing Info subfield, a Nt subfield, a Nr subfield, a Number of Tx Sectors subfield, a Number of Rx Sectors subfield, a Number of NDPs subfield, a Number of LTFs in each NDP subfield, or a NDP Tx Power subfield.

11. The STA of claim 1, wherein the STA Info field includes at least one of a AID11 subfield, a Preferred Tx Sector ID subfield, a Preferred Rx Sector ID subfield, a BW subfield, a mmW Link ID subfield, a SNR-report Required subfield, or a Blockage SNR Threshold subfield.

12. The STA of claim 10, wherein the one or more NDP PPDUs includes at least one of a mmW U-SIG field or mmW-SIG field.

13. The STA of claim 12, wherein the mmW U-SIG field includes at least one of a PHY Version subfield, a Bandwidth subfield, a mmW Band subfield, a Direction subfield, a BSS color subfield, a TXOP subfield, a PPDU Type subfield, a Channel Puncturing Info subfield, a mmW-SIG MCS subfield, or a Number of mmW-SIG Symbols subfield.

14. The STA of claim 12, wherein the mmW-SIG field includes at least one of a Number of Sectors subfield, a NDP ID subfield, a Sector ID subfield, an Antenna ID subfield, a LTF Size subfield, or a Number of LTFs subfield.
